(19) United States
(12) Patent Application Publication
(10) Pub. No.: US 2026/0070535 A1
(43) Pub. Date: Mar. 12, 2026

(54) BRAKE SYSTEM AND METHOD OF CONTROLLING THE SAME

(71) Applicant: HL MANDO CORPORATION, Pyeongtaek-si (KR)

(72) Inventors: Mankyu LEE, Pyeongtaek-si (KR); Yutae KIM, Pyeongtaek-si (KR)

(73) Assignee: HL MANDO CORPORATION, Pyeongtaek-si (KR)

(21) Appl. No.: 19/075,491

(22) Filed: Mar. 10, 2025

(30) Foreign Application Priority Data
Nov. 25, 2024 (KR) 10-2024-0170121
Sep. 12, 2024 (KR) 10-2024-0125153

(51) Int. Cl. B60T 17/22; B60T 13/74

(52) U.S. Cl. CPC B60T 17/22; B60T 13/745; B60T 2270/402; B60T 2270/415

(57) ABSTRACT

A brake system may include a brake module provided in each wheel of a vehicle, and a controller configured to perform braking control on the brake module in response to a pedal displacement signal corresponding to a movement of a brake pedal, in which the controller includes a processor configured to output a braking control signal for the brake module, and a circuit protection module configured to stabilize power supplied to the controller and remove noise, in which the circuit protection module includes at least one capacitor group including a plurality of capacitors connected to one another in parallel, and at least one circuit-breaking unit connected to the capacitor group and configured to control electrical connection of the capacitor group on the basis of a change in temperature when a failure of at least one of the plurality of capacitors is identified.

### CROSS-REFERENCE TO RELATED APPLICATIONS

This application claims the priority of Korean Patent Application No. 10-2024-0125153 filed on September 12, 2024, and Korean Patent Application No. 10-2024-0170121 filed on November 25, 2024, in the Korean Intellectual Property Office, the disclosure of which is incorporated herein by reference.

### BACKGROUND

### Technical Field

The disclosed disclosure relates to a brake system and a method of controlling the same.

### Description of Related Art

As electronic control units (ECUs) for vehicles gradually and consistently become smaller, denser and more powerful, high-energy density power sources such as lithium-ion batteries are widely used. In case that a circuit defect occurs in a device using this power source, a severe safety problem may occur. In particular, in case that a short circuit occurs because of a capacitor crack, an overcurrent flows between a battery voltage and a ground GND, and the overcurrent may cause a fatal problem that may lead to combustion and fire.

In the related art, fuses or overcurrent interruption circuits are used to prevent such risks. However, the fuse has a disadvantage of being used only once, and the overcurrent interruption circuit has various disadvantages such as power loss, complex design, and high price. Therefore, there is a need for a solution for effectively blocking an overcurrent in the event of a short circuit accident caused by a capacitor crack.

### BRIEF SUMMARY

An object to be achieved by the disclosed disclosure is to provide a brake system and a method of controlling the same, the brake system being capable of preventing secondary burnout and efficiently using a power source by effectively blocking an overcurrent in the event of a short circuit accident caused by damage to a capacitor.

Another object to be achieved by the disclosed disclosure is to provide a brake system and a method of controlling the same, the brake system being capable of being robust against damage to and/or errors of components of a vehicle and improving braking stability.

One aspect of the disclosed disclosure provides a brake system including: a brake module provided in each wheel of a vehicle; and a controller configured to perform braking control on the brake module in response to a pedal displacement signal corresponding to a movement of a brake pedal, in which the controller includes: a processor configured to output a braking control signal for the brake module; and a circuit protection module configured to stabilize power supplied to the controller and remove noise, in which the circuit protection module includes: at least one capacitor group including a plurality of capacitors connected to one another in parallel; and at least one circuit-breaking unit connected to the capacitor group and configured to control electrical connection of the capacitor group on the basis of a change in temperature when a failure of at least one of the plurality of capacitors is identified.

The brake system may further include a liquid pressure supply module configured to provide liquid pressure to the brake module, and the controller may further include: a memory; and a plurality of drive circuits configured to control a supply of a drive current related to the liquid pressure supply module.

The circuit protection module may include: a plurality of capacitor groups each connected to the processor, the memory, and the plurality of drive circuits; a plurality of circuit-breaking units each connected to any one of the plurality of capacitor groups; and a plurality of switches each connected to any one of the plurality of circuit-breaking units.

The processor may monitor at least one of a voltage and a temperature of each of the plurality of circuit-breaking units, and the processor may control an operation of at least one of the plurality of switches when a failure of at least one of the plurality of capacitors is identified on the basis of a monitoring result.

The circuit protection module may further include a voltage sensor configured to sense a voltage of the circuit-breaking unit, and the processor may monitor the voltage of the circuit-breaking unit in response to an output signal from the voltage sensor.

The circuit protection module may further include a temperature sensor configured to sense a temperature of the circuit-breaking unit, and the processor may monitor the temperature of the circuit-breaking unit in response to an output signal from the temperature sensor.

The processor may monitor at least one of a voltage and a temperature of the circuit-breaking unit and output an electrical signal related to an inspection of a state of the capacitor group on the basis of a monitoring result.

The circuit-breaking unit may include a thermistor having resistance that increases when temperature increases in accordance with a variation of a voltage caused by an overcurrent on the basis that at least one of the plurality of capacitors is short-circuited.

The thermistor may be a polymer constant-temperature resistive element in which a temperature of the element increases on the basis of the occurrence of an overcurrent, and a distance between conductive particles is increased by expansion of a polymer matrix.

The thermistor may return to a basic resistance state as the temperature of the element decreases on the basis of a cut-off of an overcurrent.

Another aspect of the disclosed disclosure provides an electronic control system including: a brake module provided in each wheel of a vehicle; and a controller configured to perform braking control on the brake module in response to a pedal displacement signal corresponding to a movement of a brake pedal, in which the controller includes: a processor configured to output a braking control signal for the brake module; and a circuit protection module configured to stabilize power supplied to the controller and remove noise, in which the circuit protection module includes: at least one capacitor group including a plurality of capacitors connected to one another in parallel; and at least one circuit-breaking unit connected to the capacitor group and configured to control electrical connection of the capacitor group on the basis of a change in temperature when a failure of at least one of the plurality of capacitors is identified.

Still another aspect of the disclosed disclosure provides a method of controlling a brake system, which includes a brake module provided in each wheel of a vehicle; and a controller configured to perform braking control on the brake module in response to a pedal displacement signal corresponding to a movement of a brake pedal, in which the controller includes: a processor configured to output a braking control signal for the brake module; and a circuit protection module configured to stabilize power supplied to the controller and remove noise, the method including: monitoring, by the processor, the circuit protection module connected to at least one capacitor group, which includes a plurality of capacitors connected to one another in parallel, and including at least one circuit-breaking unit configured to control electrical connection of the capacitor group on the basis of a change in temperature when a failure of at least one of the plurality of capacitors is identified; and blocking the electrical connection of the capacitor group on the basis of a monitoring result.

The circuit protection module may include: a plurality of capacitor groups, a plurality of circuit-breaking units each connected to any one of the plurality of capacitor groups; and a plurality of switches each connected to any one of the plurality of circuit-breaking units, and the method may further include controlling, by the processor, an operation of at least one of the plurality of switches when a failure of at least one of the plurality of capacitors is identified on the basis of the monitoring result.

The method may further include: monitoring, by the processor, at least one of a voltage and a temperature of the circuit-breaking unit.

The method may further include: monitoring, the processor, the voltage of the circuit-breaking unit made by an overcurrent in response to an output signal from a voltage sensor configured to sense the voltage of the circuit-breaking unit.

The method may further include: detecting, by the processor, the sensed voltage from the output signal from the voltage sensor, comparing the detected sensed voltage with a predesignated reference voltage, and identifying a failure of at least one of the plurality of capacitors on the basis of a comparison result.

The method may further include: monitoring, by the processor, the temperature of the circuit-breaking unit made by an overcurrent in response to an output signal from a temperature sensor configured to sense the temperature of the circuit-breaking unit.

The method may further include: detecting, the processor, the sensed temperature from the output signal from the temperature sensor, comparing the detected sensed temperature with a predesignated reference temperature, and identifying a failure of at least one of the plurality of capacitors on the basis of a comparison result.

The method may further include: controlling, by the processor, an operation of at least one of the plurality of switches in an open state when a failure of at least one of the plurality of capacitors is identified.

The method may further include: outputting, by the processor, an electrical signal related to an inspection of a state of the capacitor group on the basis of the monitoring result.

According to one aspect of the disclosed disclosure, it is possible to provide the brake system and the method of controlling the same, the brake system being capable of preventing secondary burnout and efficiently using the power source by effectively blocking an overcurrent in the event of a short circuit accident caused by damage to the capacitor.

In addition, according to one aspect of the disclosed disclosure, it is possible to the brake system and the method of controlling the same, the brake system being capable of being robust against damage to and/or errors of components of the vehicle and improving braking stability.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 is a view illustrating a brake system according to an aspect of the disclosed disclosure and a configuration of a vehicle related to the brake system;

FIG. 2 is a view illustrating a structure of a liquid pressure supply module included in the brake system according to the aspect of the disclosed disclosure;

FIG. 3 is a view illustrating an embodiment of a circuit protection module of the brake system according to the aspect of the disclosed disclosure;

FIG. 4 is a view illustrating another embodiment of the circuit protection module of the brake system according to the aspect of the disclosed disclosure; and

FIG. 5 is a view illustrating a method of controlling the brake system according to the aspect of the disclosed disclosure.

### DETAILED DESCRIPTION

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the embodiments, and the general contents in the technical field to which the disclosed disclosure pertains or the contents repeatedly described in the embodiments will be omitted. The terms 'part’, ‘module’, ‘member’, ‘block' and the like as used in the specification may be implemented in software or hardware. Further, a plurality of 'part’, ‘module’, ‘member’, ‘block' and the like may be embodied as one component. It is also possible that one 'part’, ‘module’, ‘member’, ‘block' and the like includes a plurality of components.

To elaborate, in some embodiments, the term “unit” or “module” as used herein may include any electrical circuitry, features, components, an assembly of electronic components, or the like. That is, “unit” or “module” may include any processor-based system including systems using microcontrollers, integrated circuits, chips, microchips, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “unit” or “module.” Additionally, in some embodiments, the various units or modules described herein may be included in or otherwise implemented by processing circuitry such as a microprocessor, microcontroller, or the like.

Throughout the present specification, when one constituent element is referred to as being "connected to" another constituent element, one constituent element can be "directly connected to" the other constituent element, and one constituent element can also be "indirectly connected to" the other constituent element. The indirect connection includes a connection through a wireless communication network.

In addition, unless explicitly described to the contrary, the word "comprise/include" and variations such as "comprises/includes" or "comprising/including" will be understood to imply the inclusion of stated elements, not the exclusion of any other elements.

Throughout the specification, when one member is disposed "on" another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operation principles and embodiments of the disclosed disclosure will be described in detail with reference to the accompanying drawings.

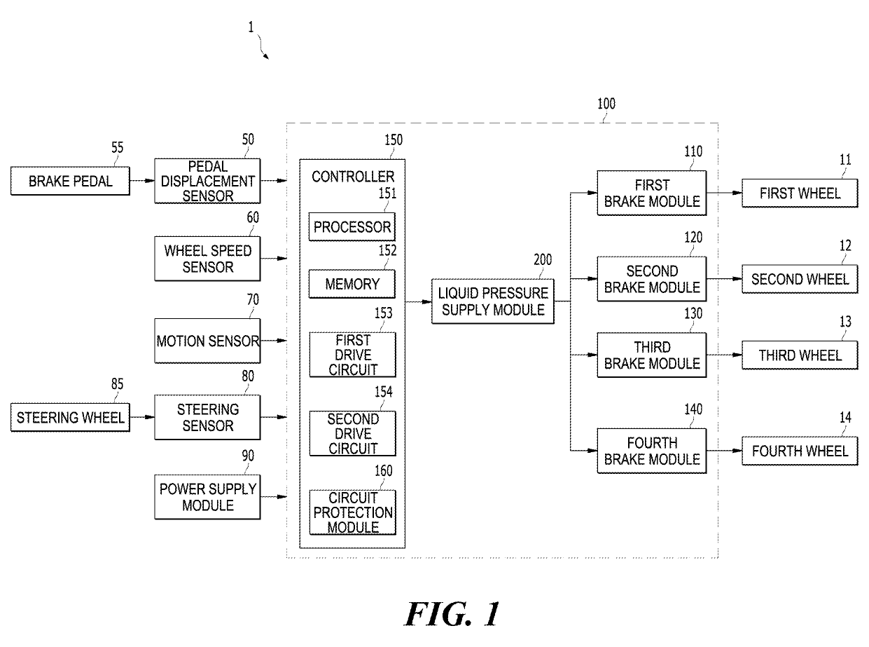

FIG. 1 is a view illustrating a brake system according to an aspect of the disclosed disclosure and a configuration of a vehicle related to the brake system.

With reference to FIG. 1, a vehicle 1 may include a plurality of wheels 11, 12, 13, and 14 configured to rotate.

For example, the plurality of wheels 11, 12, 13, and 14 may include a first wheel 11 provided at a front left side FL of the vehicle 1, a second wheel 12 provided at a front right side FR of the vehicle 1, a third wheel 13 provided at a rear left side RL of the vehicle 1, and/or a fourth wheel 14 provided at a rear right side RR of the vehicle 1. However, the number of wheels 11, 12, 13, and 14 is not limited to four.

As illustrated in FIG. 1, the vehicle 1 may include a brake pedal 55 configured to acquire an input related to braking from a driver, a pedal sensor 50 configured to detect a movement of the brake pedal 55, a wheel speed sensor 60 configured to detect rotational speeds of the wheels 11, 12, 13, and 14, a steering wheel 85 configured to acquire an input related to steering from the driver, a motion sensor 70 configured to detect a motion of the vehicle 1, a steering sensor 80 configured to detect a rotation of the steering wheel 85, a power supply module 90 configured to supply power by using a battery, and a brake system 100 configured to provide the plurality of wheels 11, 12, 13, and 14 with braking forces for stopping the vehicle 1. In this case, the pedal sensor 50, the wheel speed sensor 60, the motion sensor 70, and the steering sensor 80 are not essential components, and all or at least some of the above-mentioned components may be excluded.

The brake system 100 may include a plurality of brake modules 110, 120, 130, and 140 respectively installed in the plurality of wheels 11, 12, 13, and 14, and a controller 150 configured to control the plurality of brake modules 110, 120, 130, and 140.

The plurality of brake modules 110, 120, 130, and 140 may respectively brake the wheels 11, 12, 13, and 14, thereby braking the vehicle 1. For example, the plurality of brake modules 110, 120, 130, and 140 may include a first brake module 110 configured to brake the first wheel 11, a second brake module 120 configured to brake the second wheel 12, a third brake module 130 configured to brake the third wheel 13, and/or a fourth brake module 140 configured to brake the fourth wheel 14. The number of brake modules 110, 120, 130, and 140 is not limited to four.

The plurality of brake modules 110, 120, 130, and 140 may be provided as hydraulic brakes configured to be operated by liquid pressure to brake the wheels 11, 12, 13, and 14. In this regard, the brake system 100 may include a liquid pressure supply module 200 configured to provide liquid pressure to the plurality of brake modules 110, 120, 130, and 140.

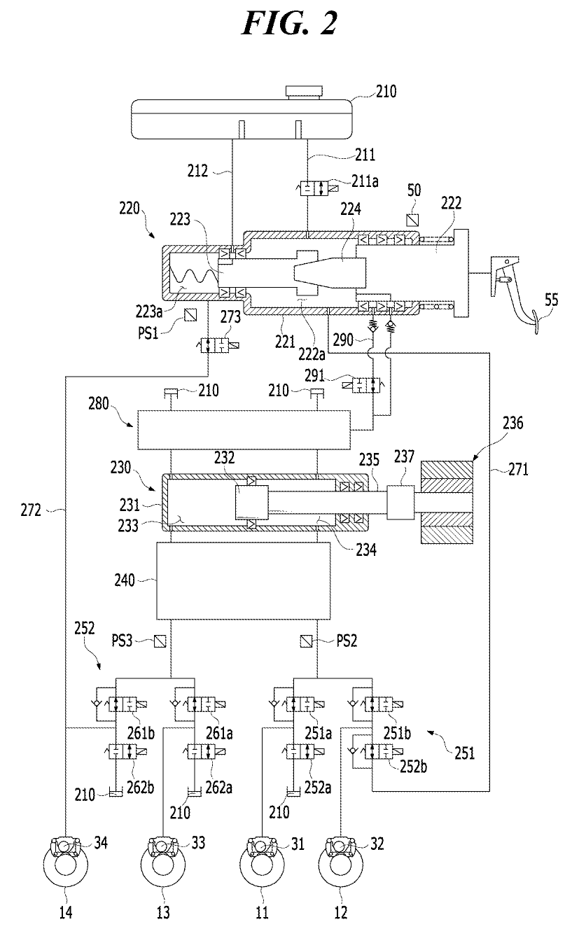

FIG. 2 is a view illustrating a structure of the liquid pressure supply module included in the brake system according to the aspect of the disclosed disclosure.

With reference to FIG. 2, the liquid pressure supply module 200 may generate liquid pressure for braking the first to fourth wheels 11, 12, 13, and 14 and provide the liquid pressure to the first to fourth brake modules 110, 120, 130, and 140.

Specifically, the liquid pressure supply module 200 may include a reservoir 210 configured to store a pressing medium, a master cylinder 220 configured to provide the driver with a reaction force corresponding to a pedal effort of the brake pedal 55 and pressurize and discharge the pressing medium such as brake oil accommodated therein, a liquid pressure supply unit 230 configured to generate liquid pressure of the pressing medium by means of a mechanical operation by receiving the driver's braking intention as a pedal displacement signal from the pedal displacement sensor 50 configured to detect a displacement of the brake pedal 55, a hydraulic control unit 240 configured to control the liquid pressure provided from the liquid pressure supply unit 230, a hydraulic circuit 250 having wheel cylinders 31 and 32 configured to brake the wheels 11, 12, 13, and 14 by receiving the liquid pressure of the pressing medium, a backup flow path 271 configured to hydraulically connect the master cylinder 220 and the hydraulic circuit 250, a dump control unit 280 provided between the liquid pressure supply unit 230 and the reservoir 210 and configured to control a flow of the pressing medium, reservoir flow paths 211 and 212 configured to hydraulically connect the reservoir 210 and the master cylinder 220, and an inspection flow path 290 connected to a master chamber of the master cylinder 220.

The reservoir 210, the master cylinder 220, the liquid pressure supply unit 230, the hydraulic control unit 240, the hydraulic circuit 250, the backup flow path 271, the dump control unit 280, the reservoir flow paths 211 and 212, and the inspection flow path 290 are not essential components and all or at least some of the above-mentioned components may be excluded.

The reservoir 210 may accommodate and/or store the pressing medium therein. The reservoir 210 may be connected to the master cylinder 220, the liquid pressure supply unit 230, and/or the hydraulic circuit 250 and supply or receive the pressing medium.

The reservoir flow paths 211 and 212 may include a first reservoir flow path 211 configured to connect a first master chamber 222a of the master cylinder 220 and the reservoir 210, and a second reservoir flow path 212 configured to connect a second master chamber 223a of the master cylinder 220 and the reservoir 210. A simulator valve 211a may be provided in the first reservoir flow path 211 and control the flow of the pressing medium between the reservoir 210 and the first master chamber 222a through the first reservoir flow path 211.

In case that the driver applies a pedal effort to the brake pedal 55 to perform the braking operation, the master cylinder 220 may provide stable pedal feel by providing the driver with a reaction force corresponding to the pedal effort. In addition, the master cylinder 220 may be configured to pressurize and discharge the pressing medium accommodated therein by the operation of the brake pedal 55.

The master cylinder 220 may include a cylinder body 221 configured to define a chamber therein, the first master chamber 222a formed at an inlet side of the cylinder body 221 to which the brake pedal 55 is connected, a first master piston 222 provided in the first master chamber 222a, connected to the brake pedal 55, and configured to be displaced by the operation of the brake pedal 55, the second master chamber 223a formed on the cylinder body 221 and formed inward or forward (leftward based on FIG. 2) of the first master chamber 222a, a second master piston 223 provided in the second master chamber 223a and configured to be displaced by the displacement of the first master piston 222 or the liquid pressure of the pressing medium accommodated in the first master chamber 222a, and a pedal simulator 224 disposed between the first master piston 222 and the second master piston 223 and configured to provide pedal feel by means of an elastic restoring force generated by compression.

The cylinder body 221, the first master chamber 222a, the first master piston 222, the second master chamber 223a, the second master piston 223, and the pedal simulator 224 are not essential components, and all or at least some of the above-mentioned components may be excluded.

The first master piston 222 and the second master piston 223 may be respectively provided in the first master chamber 222a and the second master chamber 223a and form liquid pressure or negative pressure in the pressing medium accommodated in the chambers while moving forward and rearward.

The pedal simulator 224 may be provided between the first master piston 222 and the second master piston 223 and provide the pedal feel of the brake pedal 55 to the driver by the elastic restoring force thereof.

The liquid pressure supply unit 230 may be configured to generate the liquid pressure of the pressing medium by the mechanical operation by receiving the driver's braking intention as an electrical signal from the pedal displacement sensor 50 configured to detect the displacement of the brake pedal 55.

The liquid pressure supply unit 230 may include a cylinder block 231 configured to accommodate the pressing medium, a hydraulic piston 232 accommodated in the cylinder block 231, pressure chambers 233 and 234 separated by the hydraulic piston 232 and the cylinder block 231, a liquid pressure generation motor 236 configured to generate a rotational force, a power conversion unit 237 configured to convert the rotational force of the liquid pressure generation motor 236 into a translational movement of the hydraulic piston 232, and a driving shaft 235 configured to transmit power to the hydraulic piston 232.

The cylinder block 231, the hydraulic piston 232, the pressure chambers 233 and 234, the liquid pressure generation motor 236, the power conversion unit 237, and the driving shaft 235 are not essential components of the liquid pressure supply unit 230, and at least some of the above-mentioned components may be excluded.

The pressure chambers 233 and 234 may include a first pressure chamber 233 positioned forward of the hydraulic piston 232 (leftward of the hydraulic piston 232 based on FIG. 2), and a second pressure chamber 234 positioned rearward of the hydraulic piston 232 (rightward of the hydraulic piston 232 based on FIG. 2). That is, the first pressure chamber 233 may be provided and defined by the cylinder block 231 and a front surface of the hydraulic piston 232, and a volume of the first pressure chamber 233 may change as the hydraulic piston 232 moves. In addition, the second pressure chamber 234 may be provided and defined by the cylinder block 231 and a rear surface of the hydraulic piston 232, and a volume of the second pressure chamber 234 may change as the hydraulic piston 232 moves.

When the pedal displacement sensor 50 detects the displacement of the brake pedal 55, the hydraulic piston 232 may generate the liquid pressure in the first pressure chamber 233 and generate the negative pressure in the second pressure chamber 234 while moving forward in the cylinder block 231. On the contrary, when the pedal effort of the brake pedal 55 is eliminated, the hydraulic piston 232 may generate the negative pressure in the first pressure chamber 233 and generate the liquid pressure in the second pressure chamber 234 while moving rearward in the cylinder block 231.

As described above, the liquid pressure generation motor 236 of the liquid pressure supply unit 230 may generate the liquid pressure or the negative pressure in each of the first pressure chamber 233 and the second pressure chamber 234.

The liquid pressure supply unit 230 may be hydraulically connected to the reservoir 210 by the dump control unit 280. The dump control unit 280 may include at least one flow path and at least one valve to control the flow of the pressing medium between the liquid pressure supply unit 230 and the reservoir 210.

The hydraulic control unit 240 may be configured to control the liquid pressure to be transmitted to the wheel cylinders 31, 32, 33, and 34.

The hydraulic control unit 240 may be connected to first and second hydraulic circuits 251 and 252 configured to control the flow of the liquid pressure to be transmitted to the first to fourth wheels cylinders 31, 32, 33, and 34.

The hydraulic control unit 240 may include a plurality of flow paths and a plurality of valves to guide the hydraulic pressure, which is supplied from the liquid pressure supply unit 230, to the first and second hydraulic circuits 251 and 252.

The hydraulic control unit 240 may define a flow path for providing the pressing medium to the first and second hydraulic circuits 251 and 252 by using the pressure in the first pressure chamber 233 generated by the forward movement of the hydraulic piston 232. For example, the hydraulic control unit 240 may define a flow path configured to connect the first pressure chamber 233 and the first and second hydraulic circuits 251 and 252. The pressing medium in the first pressure chamber 233 may be provided to the first and second hydraulic circuits 251 and 252 by means of the hydraulic control unit 240.

The hydraulic control unit 240 may define a flow path for providing the pressing medium to the first and second hydraulic circuits 251 and 252 by using the pressure in the second pressure chamber 234 generated by the rearward movement of the hydraulic piston 232. For example, the hydraulic control unit 240 may define a flow path configured to connect the second pressure chamber 234 and the first and second hydraulic circuits 251 and 252. The pressing medium in the second pressure chamber 234 may be provided to the first and second hydraulic circuits 251 and 252 by means of the hydraulic control unit 240.

The hydraulic control unit 240 may define a flow path for recovering the pressing medium from the first and second hydraulic circuits 251 and 252 by using the negative pressure in the first pressure chamber 233 generated by the rearward movement of the hydraulic piston 232. For example, the hydraulic control unit 240 may define a flow path configured to connect a first hydraulic circuit 251 and the first pressure chamber 233 and connect a second hydraulic circuit 252 and the first pressure chamber 233. The pressing medium in the first and second hydraulic circuits 251 and 252 may be provided to the first pressure chamber 233 through the hydraulic control unit 240.

The hydraulic control unit 240 may define a flow path for recovering the pressing medium from the first and second hydraulic circuits 251 and 252 by using the negative pressure in the second pressure chamber 234 generated by the forward movement of the hydraulic piston 232. For example, the hydraulic control unit 240 may define a flow path configured to connect the first hydraulic circuit 251 and the second pressure chamber 234 and connect the second hydraulic circuit 252 and the second pressure chamber 234. The pressing medium in the first and second hydraulic circuits 251 and 252 may be provided to the second pressure chamber 234 through the hydraulic control unit 240.

The first hydraulic circuit 251 may adjust and/or control the liquid pressure to be applied to the first and second wheel cylinders 31 and 32, and the second hydraulic circuit 252 may adjust and/or control the liquid pressure to be applied to the third and fourth wheel cylinders 33 and 34.

The first hydraulic circuit 251 may have first and second inlet valves 251a and 251b respectively disposed at upstream sides of the first and second wheel cylinders 31 and 32 and configured to control a flow of the pressing medium and the liquid pressure to be transmitted to the first and second wheel cylinders 31 and 32. The first and second inlet valves 251a and 251b may each be provided as a normal open-type solenoid valve.

In addition, the first hydraulic circuit 251 may include first and second outlet valves 252a and 252b configured to control a flow of the pressing medium discharged from the first and second wheel cylinders 31 and 32 in order to improve performance when the first and second wheel cylinders 31 and 32 perform braking release operations.

The first outlet valve 252a may be disposed at a discharge side of the first wheel cylinder 31 and control a flow of the pressing medium to be transmitted from the first wheel cylinder 31 to the reservoir 210. The first outlet valve 252a may be provided as a normal closed-type solenoid valve.

The second outlet valve 252b may be connected to (or provided in) a first backup flow path 271 corresponding to a discharge side of the second wheel cylinder 32 and control a flow of the pressing medium between the second wheel cylinder 32 and the master cylinder 220. However, the connection structure of the first backup flow path 271 is not limited thereto. For example, the first backup flow path 271 may be connected to the first wheel cylinder 31. In addition, the first backup flow path 271 may be connected to the first wheel cylinder 31 and the second wheel cylinder 32. As described above, the first backup flow path 271 may be connected to at least one of the first wheel cylinder 31 and the second wheel cylinder 32. The second outlet valve 252b may be provided as a normal open-type solenoid valve.

The second hydraulic circuit 252 may have third and fourth inlet valves 261a and 261b respectively disposed at upstream sides of the third and fourth wheel cylinders 33 and 34 and configured to control a flow of the pressing medium and the liquid pressure to be transmitted to the third and fourth wheel cylinders 33 and 34. The third and fourth inlet valves 261a and 261b may each be provided as a normal open-type solenoid valve.

In addition, the second hydraulic circuit 252 may include third and fourth outlet valves 262a and 262b configured to control a flow of the pressing medium discharged from the third and fourth wheel cylinders 33 and 34 in order to improve performance when the third and fourth wheel cylinders 33 and 34 perform braking release operations.

The third outlet valve 262a may be provided at a discharge side of the third wheel cylinder 33 and control a flow of the pressing medium to be transmitted from the third wheel cylinder 33 to the reservoir 210. The third outlet valve 262a may be provided as a normal closed-type solenoid valve.

The fourth outlet valve 262b may be provided at a discharge side of the fourth wheel cylinder 34 and control a flow of the pressing medium to be transmitted from the fourth wheel cylinder 34 to the reservoir 210. The fourth outlet valve 262b may be provided as a normal closed type solenoid valve.

A cut valve 273 may be provided in a second backup flow path 272 corresponding to a discharge side of the fourth wheel cylinder 34 and control a flow of the pressing medium between the fourth wheel cylinder 34 and the master cylinder 220.

However, the connection structure of the second backup flow path 272 is not limited thereto. For example, the second backup flow path 272 may be connected to the third wheel cylinder 33. In addition, the second backup flow path 272 may be connected to the third wheel cylinder 33 and the fourth wheel cylinder 34. As described above, the second backup flow path 272 may be connected to at least one of the third wheel cylinder 33 and the fourth wheel cylinder 34.

In case that the liquid pressure supply module 200 cannot normally operate because of a failure or the like, at least one of the first backup flow path 271 and the second backup flow path 272 may be configured to transmit the liquid pressure in the master cylinder 220 directly to the wheel cylinders 31, 32, 33, and 34 in an abnormal operating mode, i.e., a fallback mode. For example, the first backup flow path 271 may be provided to connect the first master chamber 222a of the master cylinder 220 and the first hydraulic circuit 251, and the second backup flow path 272 may be provided to connect the second master chamber 223a of the master cylinder 220 and the second hydraulic circuit 252.

The inspection flow path 290 may be provided to connect the master cylinder 220 and the dump control unit 280 and provided to inspect whether the simulator valve 211a and various types of component elements mounted in the master cylinder 220 leak.

The liquid pressure supply module 200 may include a first pressure sensor PS1 configured to measure the liquid pressure provided by the master cylinder 220, and second and third pressure sensors PS2 and PS3 configured to measure the liquid pressure of the pressing medium provided by the liquid pressure supply unit 230. The first pressure sensor PS1, the second pressure sensor PS2, and the third pressure sensor PS3 may output pressure detection signals as electrical signals representing the sensed pressure. However, the positions of the first pressure sensor PS1, the second pressure sensor PS2, and the third pressure sensor PS3 are not limited to those illustrated in FIG. 2, and the first pressure sensor PS1, the second pressure sensor PS2, and the third pressure sensor PS3 may be provided at various positions and sense the liquid pressure of the pressing medium.

With reference back to FIG. 1, the brake controller 150 may receive output signals from the pedal displacement sensor 50, the wheel speed sensor 60, the motion sensor 70, and/or steering sensor 70 and perform braking control on the plurality of brake modules 110, 120, 130, and 140.

The brake controller 150 may provide braking control signal to the plurality of brake modules 110, 120, 130, and 140 to brake the vehicle 1 in response to the electrical signal outputted from the pedal displacement sensor 50. For example, the brake controller 150 may identify a braking force (or braking acceleration) for braking the vehicle 1 in response to the output signal from the pedal displacement sensor 50 and provide the plurality of brake modules 110, 120, 130, and 140 with the braking control signal corresponding to the identified braking force (or braking acceleration).

The brake controller 150 may distribute the braking force to the plurality of brake modules 110, 120, 130, and 140 to brake the vehicle 1 in response to the electrical signal outputted from the pedal displacement sensor 50. For example, the brake controller 150 may distribute the driver's required braking force to the plurality of brake modules 110, 120, 130, and 140 and provide the plurality of brake modules 110, 120, 130, and 140 with the braking control signal corresponding to the distributed braking force. In this regard, the brake system 100 may include an electronic brake force distribution (EBD).

The brake controller 150 may provide the braking control signal to the plurality of brake modules 110, 120, 130, and 140 to temporarily allow the rotations of the plurality of wheels 11, 12, 13, and 14 in response to the electrical signal outputted from the wheel speed sensor 60. For example, the brake controller 150 may identify slips of all or some of the plurality of wheels 11, 12, 13, and 14 in response to the output signal from the wheel speed sensor 60 while the vehicle 1 is braked. The brake controller 150 may provide the plurality of brake modules 110, 120, 130, and 140 with the braking control signal that temporarily allows the rotations of the plurality of wheels 11, 12, 13, and 14 in order to eliminate the slips of the plurality of wheels 11, 12, 13, and 14 in response to the slips of the plurality of wheels 11, 12, 13, and 14. In this regard, the brake system 100 may include an anti-lock braking system (ABS).

The brake controller 150 may provide the braking control signal to the plurality of brake modules 110, 120, 130, and 140 to temporarily brake the plurality of wheels 11, 12, 13, and 14 in response to the electrical signal outputted from the wheel speed sensor 60 without the user's braking intention. For example, the brake controller 150 may identify spins of the plurality of wheels 11, 12, 13, and 14 in response to the output signal from the wheel speed sensor 60 while the vehicle 1 travels. The brake controller 150 may provide the plurality of brake modules 110, 120, 130, and 140 with the braking control signal to temporarily brake the plurality of wheels 11, 12, 13, and 14 in order to eliminate the spins of the plurality of wheels 11, 12, 13, and 14 in response to the spins of the plurality of wheels 11, 12, 13, and 14. In this regard, the brake system 100 may include a traction control system (TCS).

The brake controller 150 may provide the braking control signal to the plurality of brake modules 110, 120, 130, and 140 to temporarily brake the plurality of wheels 11, 12, 13, and 14 in response to the electrical signal outputted from the motion sensor 70 and/or the steering sensor 80. For example, the brake controller 150 may identify a reference route (reference rotation traveling route) for the vehicle 1 in response to an output signal from the steering sensor 80 while the vehicle 1 is steered, and the brake controller 150 may identify a traveling route (rotation traveling route) of the vehicle 1 in response to an output signal from the motion sensor 70 while the vehicle 1 is steered. The brake controller 150 may identify oversteering or understeering of the vehicle 1 on the basis of the reference route and the traveling route. The brake controller 150 may provide the plurality of brake modules 110, 120, 130, and 140 with the braking control signal for temporarily braking the plurality of wheels 11, 12, 13, and 14 on the basis of the oversteering and/or the understeering. In this regard, the brake system 100 may include an electronic stability control (ESC).

The brake controller 150 may provide a parking signal to the plurality of brake modules 110, 120, 130, and 140 in order to prevent the rotations of the plurality of wheels 11, 12, 13, and 14 in response to the driver's parking instruction. In this regard, the brake system 100 may include an electronic parking brake (EPB).

Regarding the above-mentioned configuration for performing braking control, the brake controller 150 may include a processor 151, a memory 152, a first drive circuit 153, a second drive circuit 154, and a circuit protection module 160.

The processor 151 may provide a control signal for controlling the operations of the components included in the brake system 100 in accordance with the driver's braking intention. The processor 151 may perform preset computation in response to output signals from the pedal displacement sensor 50 and/or the wheel speed sensor 60. In addition, the processor 151 may identify a braking force (or braking acceleration or fastening force) corresponding to the service brake, the EBD, the ABS, the TSC, the ESC, the EPB and the like on the basis of the executed computation and output a braking control signal, which corresponds to the braking force, to all or some of the plurality of brake modules 110, 120, 130, and 140.

The memory 152 may store or memorize programs and data for implementing operations of controlling the components included in the brake system 100. The memory 152 may provide the stored programs and data to the processor 151 and memorize temporary data generated during the operation of the processor 151. For example, the memory 152 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The first drive circuit 153 may control a supply of a drive current related to the motor 236 of the liquid pressure supply module 200. The motor 236 may receive the drive current controlled by the first drive circuit 153. The plurality of coils included in the stator may form a magnetic field rotated at the periphery of the rotor by the drive current, and the rotor may be rotated by a magnetic interaction between the magnetic field of the rotor and the magnetic field of the stator.

The second drive circuit 154 may control the supply of the drive current related to the inlet valves 251a, 251b, 261a, and 261b and/or the outlet valves 252a, 252b, 262a, and 262b of the liquid pressure supply module 200. In this case, the inlet valves 251a, 251b, 261a, and 261b and/or the outlet valves 252a, 252b, 262a, and 262b may each include at least one solenoid valve configured to be opened or closed by the drive current controlled by the second drive circuit 154. The solenoid valve may include a plunger configured to open or close the flow path, a spring configured to apply an elastic force to the plunger, and a coil configured to surround the plunger. The coil may form a magnetic field by the drive current, and the plunger may be moved against the elastic force of the spring by the magnetic field of the coil. Therefore, the solenoid valve may be opened or closed.

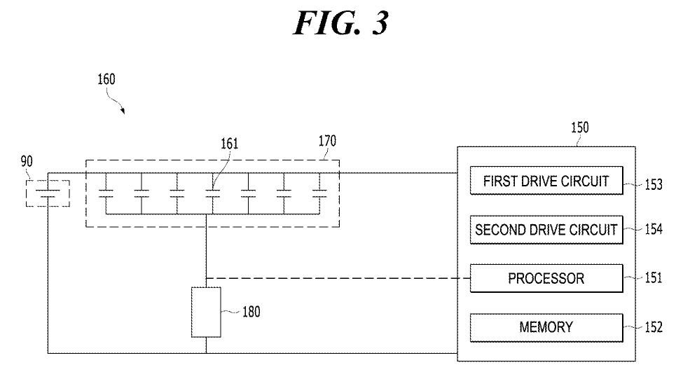

The circuit protection module 160 may stabilize the power supplied from the power supply module 90 and remove noise. In addition, the circuit protection module 160 may prevent the occurrence of overcurrent and/or fire caused by an electrical short circuit. In this regard, with reference to FIG. 3, the circuit protection module 160 may include a capacitor group 170 including a plurality of capacitors 161 connected to one another in parallel, and a circuit-breaking unit 180 connected to the capacitor group 170 and configured to control electrical connection of the capacitor group 170 on the basis of a change in temperature when it is identified that at least one of the plurality of capacitors 161 fails.

The capacitor group 170 may be provided by grouping the plurality of capacitors 161 connected to one another in parallel. In this case, the capacitor group 170 may stabilize the power supplied from the power supply module 90 and remove noise by using the plurality of capacitors 161. In this case, the capacitor 161 may be provided as a ceramic capacitor.

Because the ceramic capacitor includes several layered structures, the ceramic capacitor is advantageous in designing a miniaturized product with a high capacity. Because the ceramic capacitor has a low equivalent series resistance (ESR), the ceramic capacitor causes a small loss of electric power, such that the ceramic capacitor may be used as a bypass capacitor and a noise filter. Because of the nature of the ceramic material, the ceramic capacitor may be robust against temperature, humidity, and vibration. The ceramic capacitor is suitable for a surface-mount technology (SMT) process, such that the ceramic capacitor may be used by being mounted on a printed circuit board (PCB). However, burnout, such as an internal crack, may occur in the ceramic capacitor in case that an abnormal rated voltage or a rapid change in temperature occurs because of the layered structure.

The circuit-breaking unit 180 may be connected in series to the capacitor group and connected to a ground terminal (GND). The circuit-breaking unit 180 may include a thermistor having a resistance that increases when a temperature increases on the basis that at least one of the plurality of capacitors 161 is short-circuited. In this case, the thermistor may include a positive temperature coefficient (PTC) element, which is a constant-temperature resistive element, in more detail, a polymeric positive temperature coefficient (PPTC) element that is a polymer constant-temperature resistive element.

The PPTC element may be a resettable fuse with a characteristic that the resistance changes rapidly depending on the temperature. In general, a structure in which conductive particles (mainly carbon black) are dispersed in a non-conductive polymer matrix allows the conductive particles to come into contact with one another to form a current path and maintain a low resistance state in a normal state. In addition, when an overcurrent occurs in the PPTC element, the temperature of the element may be increased by heat, and the distance between conductive particles may be increased by the expansion of the polymer matrix. As a result, the PPTC element may operate on the principle of blocking overcurrent by rapidly increasing resistance. Thereafter, when the current is cut off and the PPTC element is cooled, the state may return to a low-resistance state because of the polymer contraction and the restoration of contact between conductive particles. For example, the PPTC element operates in a low-resistance state below the holding current or operates in a high-resistance state above the tripping current, and the operating region may be divided depending on the temperature and current.

The tripping time of the PPTC element is the time required for the PPTC element to trip from the moment when the fault current occurs, and the tripping time may vary depending on the magnitude of the fault current and the temperature. The tripping event occurs when the rate of thermal energy loss is lower than the rate of thermal energy generation, and the rate of the increase in temperature and the total energy and time required to trip the PPTC element may vary depending on the fault current and heat transfer environment. Under normal operating conditions, the heat generated by the element and the heat lost may be balanced.

Therefore, the thermistor has a low basic resistance under normal conditions, but the resistance may increase rapidly when the temperature is increased by an overcurrent. For example, the thermistor may block overcurrent by increasing resistance momentarily when a short circuit occurs because of the burnout of the capacitor 161. In addition, the thermistor may be used repeatedly because the thermistor automatically returns to the original state (basic resistance state) on the basis of a cut-off of overcurrent.

The processor 151 may monitor a voltage of the circuit-breaking unit 180. In addition, the processor 151 may inspect a state of the capacitor group 170 on the basis of the monitoring result. For example, the processor 151 may monitor a voltage of the circuit-breaking unit 180 in response to an output signal from a voltage sensor 195 provided at a front end of the circuit-breaking unit 180. When a failure of at least one of the plurality of capacitors 161 is identified in accordance with a variation of voltage caused by overcurrent, the processor 151 may output an electrical signal related to the inspection of the state of the capacitor group 170. Therefore, the processor 151 may perform feedback on the inspection of the capacitor group 170 to the vehicle 1 and/or the user.

Alternatively, the processor 151 may monitor a temperature of the circuit-breaking unit 180 and inspect the state of the capacitor group 170 on the basis of the monitoring result. For example, the processor 151 may monitor a temperature of the circuit-breaking unit 180 in response to an output signal from a temperature sensor 196 provided in the circuit-breaking unit 180. When an increase in temperature to a reference temperature or higher is identified and a failure of at least one of the plurality of capacitors 161 is identified, the processor 151 may output an electrical signal related to the inspection of the state of the capacitor group 170. In this case, the reference temperature may be set to the temperature corresponding to the increase in resistance that enables the cut-off of the overcurrent.

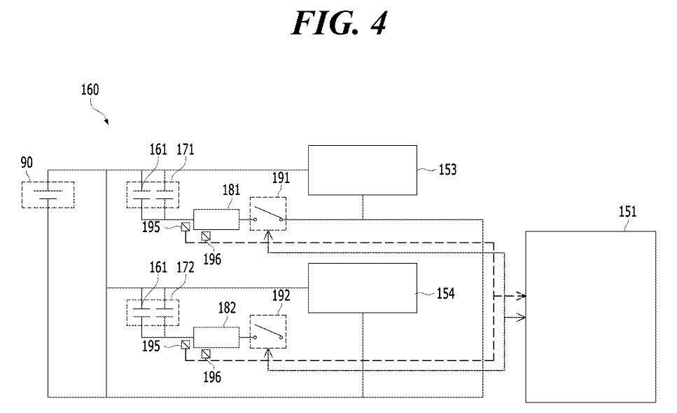

FIG. 4 is a view illustrating another embodiment of the circuit protection module of the brake system according to the aspect of the disclosed disclosure.

In this case, in order to avoid the repeated description, the description will focus on the circuit protection module 160 and the processor 151.

With reference to FIG. 4, the circuit protection module 160 may include a plurality of capacitor groups 171 and 172 each including the plurality of capacitors 161, a plurality of circuit-breaking units 181 and 182 each connected to any one of the plurality of capacitor groups 171 and 172, and a plurality of switches 191 and 192 each connected to any one of the plurality of circuit-breaking units 181 and 182.

The plurality of capacitor groups 171 and 172 may be connected in parallel to one another and provided by grouping the predesignated number of capacitors 161. The plurality of capacitor groups 171 and 172 may include a first capacitor group 171 and a second capacitor group 172. However, the plurality of capacitor groups 171 and 172 are not limited thereto. The plurality of capacitor groups 171 and 172 may be provided as various numbers of groups each connected to the processor 151, the memory 152, and the plurality of drive circuits 153 and 154.

The first capacitor group 171 may stabilize the power supplied from the power supply module 90 to the first drive circuit 153 and remove noise. For example, the first capacitor group 171 provided by grouping the two capacitors 161 may remove noise components of the power supplied from the power supply module 90 to the first drive circuit 153. In this case, the capacitors 161 grouped into the first capacitor group 171 may be connected to the first drive circuit 153 in a circuit manner.

The second capacitor group 172 may stabilize the power supplied from the power supply module 90 to the second drive circuit 154 and remove noise. For example, the second capacitor group 172 provided by grouping the two capacitors 161 may remove noise components of the power supplied from the power supply module 90 to the second drive circuit 154. In this case, the capacitors 161 grouped into the second capacitor group 172 may be connected to the second drive circuit 154 in a circuit manner.

The plurality of circuit-breaking units 181 and 182 may include a first circuit-breaking unit 181 and a second circuit-breaking unit 182 respectively connected to the first capacitor group 171 and the second capacitor group 172.

The first circuit-breaking unit 181 may be connected in series to the first capacitor group 171. When the temperature is increased on the basis that the first capacitor group 171 is short-circuited, the resistance value increases, such that the first circuit-breaking unit 181 may cut off the supply of power to the first drive circuit 153.

The second circuit-breaking unit 182 may be connected in series to the second capacitor group 172. When the temperature is increased on the basis that the second capacitor group 172 is short-circuited, the resistance value increases, such that the second circuit-breaking unit 182 may cut off the supply of power to the second drive circuit 154.

The plurality of switches 191 and 192 may include a first switch 191 and a second switch 192 respectively connected to the first circuit-breaking unit 181 and the second circuit-breaking unit 182.

The first switch 191 may be connected in series to the first circuit-breaking unit 181 and operate in an open or closed state in response to the control signal from the processor 151.

The second switch 192 may be connected in series to the second circuit-breaking unit 182 and operate in an open or closed state in response to the control signal from the processor 151.

The processor 151 may monitor the voltage of at least one of the first circuit-breaking unit 181 and the second circuit-breaking unit 182. When a failure of at least one of the plurality of capacitors 161 is identified on the basis of the monitoring result, the processor 151 may control the operation of at least one of the first switch 191 and the second switch 192. In this case, the processor 151 may monitor the voltage of at least one of the first circuit-breaking unit 181 and the second circuit-breaking unit 182 in response to the output signal from the voltage sensor 195 provided at the front end of at least one of the first circuit-breaking unit 181 and the second circuit-breaking unit 182. When a variation of the voltage caused by the overcurrent is monitored, the processor 151 may transmit a control signal (ON signal/OFF signal) to at least one of the first switch 191 and the second switch 192 so that at least one of the first switch 191 and the second switch 192 operates in the open or closed state.

For example, the processor 151 may block the introduction of the overcurrent into the first circuit-breaking unit 181 by opening the first switch 191 connected to the first capacitor group 171 in which a failure of the capacitor 161 is identified. In addition, the temperature of the first circuit-breaking unit 181 decreases on the basis of the cut-off the overcurrent, such that the first circuit-breaking unit 181 may return to the basic resistance state.

Alternatively, the processor 151 may monitor the temperature of at least one of the first circuit-breaking unit 181 and the second circuit-breaking unit 182 in response to the output signal from the temperature sensor 196 provided in at least one of the first circuit-breaking unit 181 and the second circuit-breaking unit 182. When the increase in temperature to the reference temperature or higher is identified, the processor 151 may transmit the control signal (ON signal/OFF signal) to at least one of the first switch 191 and the second switch 192 so that at least one of the first switch 191 and the second switch 192 operates in the open or closed state. In this case, the reference temperature may be set to the temperature corresponding to the increase in resistance that enables the cut-off of the overcurrent.

In the brake system 100, the plurality of capacitor groups 171 and 172, which are respectively connected to the modules (e.g., any one of the first drive circuit 153 and the second drive circuit 154) of the controller 150, are connected to the different first and second circuit-breaking units 181 and 182, thereby minimizing the influence to the other modules (e.g., the other of the first drive circuit 153 and the second drive circuit 154) when the capacitor 161 fails.

In addition, when the capacitor 161 fails, the processor 151 of the brake system 100 may monitor the failure and operate, in the open state, any one of the first switch 191 and the second switch 192 respectively connected to the modules (e.g., any one of the first drive circuit 153 and the second drive circuit 154), thereby preventing the occurrence of secondary burnout and fire.

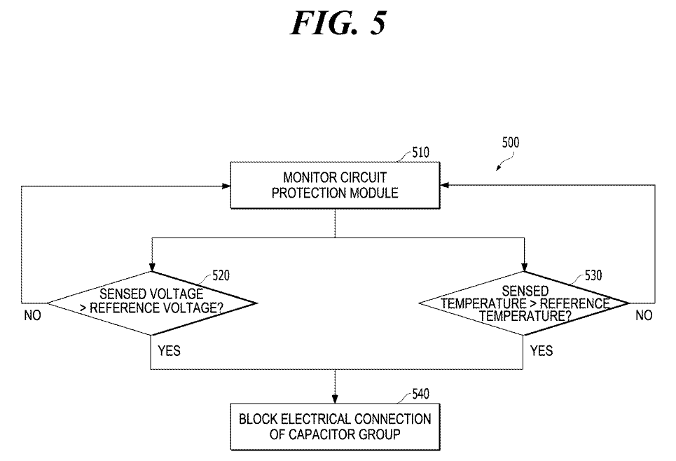

FIG. 5 is a view illustrating a method of controlling the brake system according to the aspect of the disclosed disclosure.

In this case, the method of controlling the above-mentioned brake system will be described.

With reference to FIG. 5, the method of controlling the brake system according to the aspect of the disclosed disclosure may monitor the circuit protection module 160 including at least one circuit-breaking unit 180 configured to control the electrical connection of the capacitor group 170 on the basis of the change in temperature when the processor 151 is connected to at least one capacitor group 170, which includes the plurality of capacitors connected to one another in parallel, and a failure of at least one of the plurality of capacitors 161 is identified (510).

In this case, the processor 151 may monitor at least one of the voltage and the temperature of the circuit-breaking unit 180. In this case, the processor 151 may monitor the voltage of the circuit-breaking unit 180 made by the overcurrent in response to the output signal from the voltage sensor 195 configured to sense the voltage of the circuit-breaking unit 180. In addition, the processor 151 may monitor the temperature of the circuit-breaking unit 180 made by the overcurrent in response to the output signal from the temperature sensor 196 configured to sense the temperature of the circuit-breaking unit 180.

Next, the processor 151 may detect the sensed voltage from the output signal from the voltage sensor, compare the detected sensed voltage with a predesignated reference voltage, and identify a failure of at least one of the plurality of capacitors 161 on the basis of the comparison result (S520).

In addition, the processor 151 may detect the sensed temperature from the output signal from the voltage sensor, compare the detected sensed temperature with a predesignated reference temperature, and identify a failure of at least one of the plurality of capacitors on the basis of the comparison result (S530).

Next, when a failure of at least one of the plurality of capacitors 161 is identified on the basis of the monitoring result, the processor 151 may block the electrical connection of the capacitor group 170 by controlling the operation of at least one of the plurality of switches 191 and 192 (540).

In this case, when a failure of at least one of the plurality of capacitors 161 is identified, the processor 151 may control the operation of at least one of the plurality of switches 191 and 192 in the open state (open at least one of the plurality of switches 191 and 192).

According to one aspect of the disclosed disclosure, it is possible to provide the brake system and the method of controlling the same, the brake system being capable of preventing secondary burnout and efficiently using the power source by effectively blocking an overcurrent in the event of a short circuit accident caused by damage to the capacitor.

In addition, according to one aspect of the disclosed disclosure, it is possible to the brake system and the method of controlling the same, the brake system being capable of being robust against damage to and/or errors of components of the vehicle and improving braking stability.

On the other hand, the disclosed embodiments may be implemented in the form of a recording medium that stores computer-executable instructions. The instruction may be stored in the form of a program code. When the instruction is executed by a processor, a program module may be generated, and operations of the disclosed embodiments may be performed. The recording medium may be implemented as a computer-readable recording medium.

Examples of the computer-readable recording medium include all kinds of recording media for storing instructions readable by a computer. Specific examples thereof may include a read only memory (ROM), a random access memory (RAM), a magnetic tape, a magnetic disc, a flash memory, an optical data storage device, and the like.

The machine-readable storage medium may be provided in the form of a non-transitory storage medium. Here, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium. For example, a "non-transitory storage medium" may include a buffer that temporarily stores data.

While the disclosed embodiments have been described above with reference to the accompanying drawings, the embodiments are just illustrative and not intended to limit the present specification. It can be appreciated that various modifications and alterations, which are not described above, may be made to the present embodiment by those skilled in the art to which the present specification pertains without departing from the intrinsic features of the present disclosure. The respective constituent elements specifically described in the embodiments may be modified and then carried out. Further, it should be interpreted that the differences related to the modifications and applications are included in the scope of the present specification defined by the appended claims.

1. A brake system comprising:
a brake module provided in each wheel of a vehicle; and
a controller configured to perform braking control on the brake module in response to a pedal displacement signal corresponding to a movement of a brake pedal,
wherein the controller comprises:
a processor configured to output a braking control signal for the brake module; and
a circuit protection module configured to stabilize power supplied to the controller and remove noise,
wherein the circuit protection module comprises:
at least one capacitor group comprising a plurality of capacitors connected to one another in parallel; and
at least one circuit-breaking unit connected to the capacitor group and configured to control electrical connection of the capacitor group on the basis of a change in temperature when a failure of at least one of the plurality of capacitors is identified.

2. The brake system of claim 1, wherein the brake system further comprises a liquid pressure supply module configured to provide liquid pressure to the brake module and
wherein the controller further comprises:
a memory; and
a plurality of drive circuits configured to control a supply of a drive current related to the liquid pressure supply module.

3. The brake system of claim 2, wherein the circuit protection module comprises:
a plurality of capacitor groups each connected to the processor, the memory, and the plurality of drive circuits;
a plurality of circuit-breaking units each connected to any one of the plurality of capacitor groups; and
a plurality of switches each connected to any one of the plurality of circuit-breaking units.

4. The brake system of claim 2, wherein the processor monitors at least one of a voltage and a temperature of each of the plurality of circuit-breaking units and
wherein the processor controls an operation of at least one of the plurality of switches when a failure of at least one of the plurality of capacitors is identified on the basis of a monitoring result.

5. The brake system of claim 4, wherein the circuit protection module further comprises a voltage sensor configured to sense a voltage of the circuit-breaking unit and
wherein the processor monitors the voltage of the circuit-breaking unit in response to an output signal from the voltage sensor.

6. The brake system of claim 4, wherein the circuit protection module further comprises a temperature sensor configured to sense a temperature of the circuit-breaking unit and
wherein the processor monitors the temperature of the circuit-breaking unit in response to an output signal from the temperature sensor.

7. The brake system of claim 1, wherein the processor monitors at least one of a voltage and a temperature of the circuit-breaking unit and outputs an electrical signal related to an inspection of a state of the capacitor group on the basis of a monitoring result.

8. The brake system of claim 1, wherein the circuit-breaking unit comprises a thermistor having resistance that increases when temperature increases in accordance with a variation of a voltage caused by an overcurrent on the basis that at least one of the plurality of capacitors is short-circuited.

9. The brake system of claim 8, wherein the thermistor is a polymer constant-temperature resistive element in which a temperature of the element increases on the basis of the occurrence of an overcurrent, and a distance between conductive particles is increased by expansion of a polymer matrix.

10. The brake system of claim 9, wherein the thermistor returns to a basic resistance state as the temperature of the element decreases on the basis of a cut-off of an overcurrent.

11. An electronic control system comprising:
a brake module provided in each wheel of a vehicle; and
a controller configured to perform braking control on the brake module in response to a pedal displacement signal corresponding to a movement of a brake pedal,
wherein the controller comprises:
a processor configured to output a braking control signal for the brake module; and
a circuit protection module configured to stabilize power supplied to the controller and remove noise,
wherein the circuit protection module comprises:
at least one capacitor group comprising a plurality of capacitors connected to one another in parallel; and
at least one circuit-breaking unit connected to the capacitor group and configured to control electrical connection of the capacitor group on the basis of a change in temperature when a failure of at least one of the plurality of capacitors is identified.

12. A method of controlling a brake system, which comprises a brake module provided in each wheel of a vehicle; and
a controller configured to perform braking control on the brake module in response to a pedal displacement signal corresponding to a movement of a brake pedal,
wherein the controller comprises:
a processor configured to output a braking control signal for the brake module; and
a circuit protection module configured to stabilize power supplied to the controller and remove noise, the method comprising:
monitoring, by the processor, the circuit protection module connected to at least one capacitor group, which comprises a plurality of capacitors connected to one another in parallel, and comprising at least one circuit-breaking unit configured to control electrical connection of the capacitor group on the basis of a change in temperature when a failure of at least one of the plurality of capacitors is identified; and
blocking the electrical connection of the capacitor group on the basis of a monitoring result.

13. The method of claim 12, wherein the circuit protection module comprises:
a plurality of capacitor groups, a plurality of circuit-breaking units each connected to any one of the plurality of capacitor groups; and
a plurality of switches each connected to any one of the plurality of circuit-breaking units and
wherein the method further comprises controlling, by the processor, an operation of at least one of the plurality of switches when a failure of at least one of the plurality of capacitors is identified on the basis of the monitoring result.

14. The method of claim 13, further comprising:
monitoring, by the processor, at least one of a voltage and a temperature of the circuit-breaking unit.

15. The method of claim 14, further comprising:
monitoring, the processor, the voltage of the circuit-breaking unit made by an overcurrent in response to an output signal from a voltage sensor configured to sense the voltage of the circuit-breaking unit.

16. The method of claim 15, further comprising:
detecting, by the processor, the sensed voltage from the output signal from the voltage sensor, comparing the detected sensed voltage with a predesignated reference voltage, and identifying a failure of at least one of the plurality of capacitors on the basis of a comparison result.

17. The method of claim 14, further comprising:
monitoring, by the processor, the temperature of the circuit-breaking unit made by an overcurrent in response to an output signal from a temperature sensor configured to sense the temperature of the circuit-breaking unit.

18. The method of claim 17, further comprising:
detecting, the processor, the sensed temperature from the output signal from the temperature sensor, comparing the detected sensed temperature with a predesignated reference temperature, and identifying a failure of at least one of the plurality of capacitors on the basis of a comparison result.

19. The method of claim 13, further comprising:
controlling, by the processor, an operation of at least one of the plurality of switches in an open state when a failure of at least one of the plurality of capacitors is identified.

20. The method of claim 12, further comprising:
outputting, by the processor, an electrical signal related to an inspection of a state of the capacitor group on the basis of the monitoring result.
